(19) United States
(12) Patent Application Publication
(10) Pub. No.: US 2025/0368204 A1
(43) Pub. Date: Dec. 4, 2025

(54) METHOD AND SYSTEM FOR ASSISTING A DISTRACTED DRIVER

(71) Applicant: Volvo Car Corporation, Göteborg (SE)

(72) Inventors: Fredrik Törner, Göteborg (SE); Alexander Eriksson, Göteborg (SE); Derong Yang, Göteborg (SE); Viktor Larsson, Göteborg (SE); Anders Ödblom, Göteborg (SE)

(21) Appl. No.: 18/679,615

(22) Filed: May 31, 2024

(51) Int. Cl. B60W 40/08; B60W 30/14; B60W 50/14; B60W 60/00; G06V 20/59; G10L 15/08

(52) U.S. Cl. CPC B60W 40/08; B60W 30/146; B60W 50/14; B60W 60/0051; G06V 20/597; G10L 15/08; B60W 2540/229; G10L 2015/088

(57) ABSTRACT

A system for assisting a distracted vehicle occupant. The system includes a first occupant sensor configured to capture data indicative of an emotional state of an occupant of a vehicle. The system also includes a distraction determination module configured to recognize that the occupant is in a high emotional state based on the captured data indicative of the emotional state of the occupant. The distraction determination module is also configured to determine one or more corrective actions configured to calm the occupant from the high emotional state to a normal emotional state in response to the recognized high emotional state of the occupant. The distraction determination module is further configured to implement or cause to be implemented the corrective action(s).

### TECHNICAL FIELD

The present disclosure relates generally to the automotive field. More particularly, the present disclosure relates to assisting distracted or emotional vehicle occupants.

### BACKGROUND

Currently, some vehicles monitor occupants for distractions related to sleepiness or not paying attention to the road. For example, lane monitoring systems and collision avoidance systems may produce tactile feedback, alert tones, or the like to refocus a distracted or sleepy driver of the vehicle on driving the vehicle after the distracted driver has failed to drive the vehicle safely. However, vehicles collisions, accidents, etc. are often caused by occupants of the vehicle distracted with strong emotions such as anger, sadness, hysteria, and the like. Existing systems to assist distracted drivers only operate after the driver has made a mistake or is in the process of making a mistake.

As such, a need exists in the art for a system and associated method and control system for a vehicle that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide systems for assisting a distracted vehicle occupant and associated methods of operation and control systems that overcome the limitations of the known art. Thus, the present disclosure is directed to a system for assisting a distracted vehicle occupant and associated computer-implemented method.

Embodiments of the disclosed systems and methods facilitate first sensing an angry, disturbed, or even suicidal driver or occupant using internal cameras, microphones, and sensors and a variety of artificial intelligence algorithms, for example. These sensors sense loud speech and arguments (between occupants, between a driver and someone on a mobile device, etc.) and hostile facial expressions and other movements, for example, sensing anything that indicates a heightened emotional state by any available means. Once detected, vehicle sensors may be tuned for enhanced detection, soothing ambient sounds/music may be provided, pilot assist may be instituted, progressive safety alerts may be provided, vehicle controls may be deadened, autonomous control may be implemented, mobile devices may be disabled, etc., such that the driver and others in the vehicle may be calmed and made more responsive to ensure the occupants' and surroundings' safety. In a detected suicide case, autonomous control may be implemented and a link to assistance may be initiated. In this sense, the vehicle may act as a virtual mediator/therapist until a safe vehicle operation situation is restored, with a calm, attentive driver.

To achieve the foregoing and other objects and advantages, in one aspect, the present subject matter is directed to a system for assisting a distracted vehicle occupant. The system includes a first occupant sensor configured to capture data indicative of an emotional state of an occupant of a vehicle. The system also includes a distraction determination module comprising instructions stored in at least one memory and executable by one or more processors to cause the distraction determination module to recognize that the occupant is in a high emotional state based on the captured data indicative of the emotional state of the occupant. The instructions of the distraction determination module, when executed by the processor(s), further cause the distraction determination module to determine one or more corrective actions configured to calm the occupant from the high emotional state to a normal emotional state in response to the recognized high emotional state of the occupant. The instructions of the distraction determination module, when executed by the processor(s), also cause the distraction determination module to implement or cause to be implemented the corrective action(s).

In at least one embodiment, the occupant may include a driver or operator of the vehicle. Additionally or alternatively, the high emotional state may be associated with one or more of occupant speech over a predetermined db level, an argument involving the occupant, the use of one or more trigger words by the occupant, an emotional facial expression of the occupant, or an erratic movement of the occupant. In some embodiments, the high emotional state may be recognized utilizing an artificial intelligence algorithm. In some such embodiments or other embodiments, the instructions of the distraction determination module, when executed by the processor(s), may further cause the distraction determination module to receive the captured data indicative of the emotional state of the occupant of the vehicle at a first predetermined time interval prior to recognizing that the occupant is in the high emotional state. Additionally or alternatively, the instructions of the distraction determination module, when executed by the processor(s), may cause the distraction determination module to receive the captured data indicative of the emotional state of the occupant at a second predetermined time interval shorter than the first predetermined time interval in response to the recognized high emotional state of the occupant.

In an additional or alternative embodiment, the system may further include a second occupant sensor different than the first occupant sensor and also configured to capture the data indicative of the emotional state of the occupant of the vehicle. In some such embodiments, the instructions of the distraction determination module, when executed by the processor(s), may cause the distraction determination module to receive the captured data indicative of the emotional state of the occupant of the vehicle from the first occupant sensor but the not the second occupant sensor prior to recognizing that the occupant is in the high emotional state. Additionally or alternatively, the instructions of the distraction determination module, when executed by the processor(s), may cause the distraction determination module to receive the captured data indicative of the emotional state of the occupant of the vehicle from the first occupant sensor and the second occupant sensor in response to the recognized high emotional state of the occupant. Additionally or alternatively, the first occupant sensor may include an audio sensor or a microphone, and the second occupant sensor may include a visual sensor or camera.

Additionally or alternatively, the corrective action(s) may include one or more of playing soothing ambient sounds or music, turning off a sound system of the vehicle, activating a driver assistance system of the vehicle, activating an autonomous driving system of the vehicle, alerting the occupant of the vehicle of the high emotional state, reducing the sensitivity of one or more vehicle controls, preventing use of a mobile device of the occupant, reducing a travel speed or maximum speed of the vehicle, or establishing a communication link between the occupant and assistance. In further or alternative embodiments, causing the corrective action(s) to be implemented may include communicating a signal one or more of a subsystem of the system, another module of the system, or another system of the vehicle suitable to implement the corrective action(s).

In an additional or alternative embodiment, the instructions of the distraction determination module, when executed by the processor(s), may cause the distraction determination module to receive updated captured data indicative of an updated emotional state of the occupant of the vehicle subsequent to implementation of the corrective action(s). In some such embodiments or different embodiments, the instructions of the distraction determination module, when executed by the processor(s), may cause the distraction determination module to recognize that the occupant is in a normal emotional state based on the updated captured data indicative of the updated emotional state of the occupant. Furthermore, the instructions of the distraction determination module, when executed by the processor(s), may cause the distraction determination module to terminate or cause to be terminated the corrective action(s). In an additional or alternative embodiment, the instructions of the distraction determination module, when executed by the processor(s), may cause the distraction determination module to recognize that the occupant is still in the high emotional state based on the updated captured data indicative of the updated emotional state of the occupant. In some such embodiments or different embodiments, the instructions of the distraction determination module, when executed by the processor(s), may cause the distraction determination module to determine one or more additional corrective actions configured to calm the occupant from the high emotional state to the normal emotional state in response to recognizing that the occupant is still in the high emotional state. In some such embodiments or different embodiments, the instructions of the distraction determination module, when executed by the processor(s), may cause the distraction determination module to implement or cause to be implemented the additional corrective action(s).

In an additional or alternative aspect, the present subject matter is directed to a non-transitory computer-readable medium comprising instructions stored in at least one memory that, when executed by one or more processors, cause the one or more processors to carry out steps. The steps include capturing data indicative of an emotional state of an occupant of a vehicle. The steps further include recognizing that the occupant is in a high emotional state based on the captured data indicative of the emotional state of the occupant. Another step includes determining one or more corrective actions configured to calm the occupant from the high emotional state to a normal emotional state in response to the recognized high emotional state of the occupant. The steps further include implementing the at least one corrective action.

In at least one embodiment, the occupant may include a driver or operator of the vehicle. Additionally or alternatively, the high emotional state may be associated with one or more of occupant speech over a predetermined db level, an argument involving the occupant, the use of at least one trigger word by the occupant, an emotional facial expression of the occupant, or an erratic movement of the occupant. In further or different embodiments, the steps may further include receiving the captured data indicative of the emotional state of the occupant of the vehicle at a first predetermined time interval prior to recognizing that the occupant is in the high emotional state. Additionally or alternatively, the steps may include receiving the captured data indicative of the emotional state of the occupant at a second predetermined time interval in response to the recognized high emotional state of the occupant. In some such embodiments or different embodiments, the second predetermined time interval may be shorter than the first predetermined time interval.

In an additional or alternative embodiment, the data indicative of the emotional state of the occupant of the vehicle may be captured utilizing a first occupant sensor prior to recognizing that the occupant is in the high emotional state. Additionally or alternatively, the steps may further include capturing again data indicative of the emotional state of the occupant of the vehicle utilizing a second occupant sensor different than the first occupant sensor in response to the recognized high emotional state of the occupant. In some such embodiments or different embodiments, wherein the first occupant sensor may include an audio sensor or a microphone, and the second occupant sensor may include a visual sensor or camera.

In further or different embodiments, the corrective action(s) may include one or more of playing soothing ambient sounds or music, turning off a sound system of the vehicle, activating a driver assistance system of the vehicle, activating an autonomous driving system of the vehicle, alerting the occupant of the vehicle of the high emotional state, reducing the sensitivity of one or more vehicle controls, preventing use of a mobile device of the occupant, reducing a travel speed or a maximum speed of the vehicle, or establishing a communication link between the occupant and assistance.

In additional or alternative embodiments, the steps may further include capturing updated data indicative of an updated emotional state of the occupant of the vehicle subsequent to implementing the at least one corrective action. Furthermore or alternatively, the steps may include recognizing that the occupant is in a normal emotional state based on the updated data indicative of the updated emotional state of the occupant. In some such embodiments or different embodiments, the steps may include terminating the corrective action(s). Additionally or alternatively, the steps may include recognizing that the occupant is still in the high emotional state based on the updated data indicative of the updated emotional state of the occupant. In at least one such embodiment or a different embodiments, the steps may include determining one or more additional corrective actions configured to calm the occupant from the high emotional state to the normal emotional state in response to recognizing that the occupant is still in the high emotional state. In some such embodiments or different embodiments, the steps may include implementing the additional corrective action(s).

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic diagram of an exemplary embodiment of a system for assisting a distracted vehicle occupant, in accordance with aspects of the present subject matter;

FIG. 2 illustrates a schematic logic diagram of an exemplary embodiment of a system for assisting a distracted vehicle occupant, in accordance with aspects of the present subject matter;

FIG. 3 illustrates an exemplary embodiment of a method for assisting a distracted vehicle occupant, in accordance with aspects of the present subject matter;

FIG. 4 illustrates a schematic diagram of an exemplary embodiment of a network of a cloud-based system for implementing various cloud-based services, in accordance with aspects of the present subject matter;

FIG. 5 illustrates a schematic diagram of an exemplary embodiment of a server which may be used in the cloud-based system of FIG. 4 or stand-alone, in accordance with aspects of the present subject matter; and

FIG. 6 illustrates a schematic diagram of an exemplary embodiment of a user device which may be used in the cloud-based system of FIG. 4 or stand-alone, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, embodiments of the disclosed systems and methods facilitate first sensing an angry, disturbed, or even suicidal driver or occupant using internal cameras, microphones, and sensors and a variety of artificial intelligence algorithms, for example. These sensors sense loud speech and arguments (between occupants, between a driver and someone on a mobile device, etc.) and hostile facial expressions and other movements, for example, sensing anything that indicates a heightened emotional state by any available means. Once detected, vehicle sensors may be tuned for enhanced detection, soothing ambient sounds/music may be provided, pilot assist may be instituted, progressive safety alerts may be provided, vehicle controls may be deadened, autonomous control may be implemented, mobile devices may be disabled, etc., such that the driver and others in the vehicle may be calmed and made more responsive to ensure the occupant and surroundings personal safety. In a detected suicide case, autonomous control may be implemented and a link to assistance may be initiated. In this sense, the vehicle may act as a virtual mediator/therapist until a safe vehicle operation situation is restored, with a calm, attentive driver.

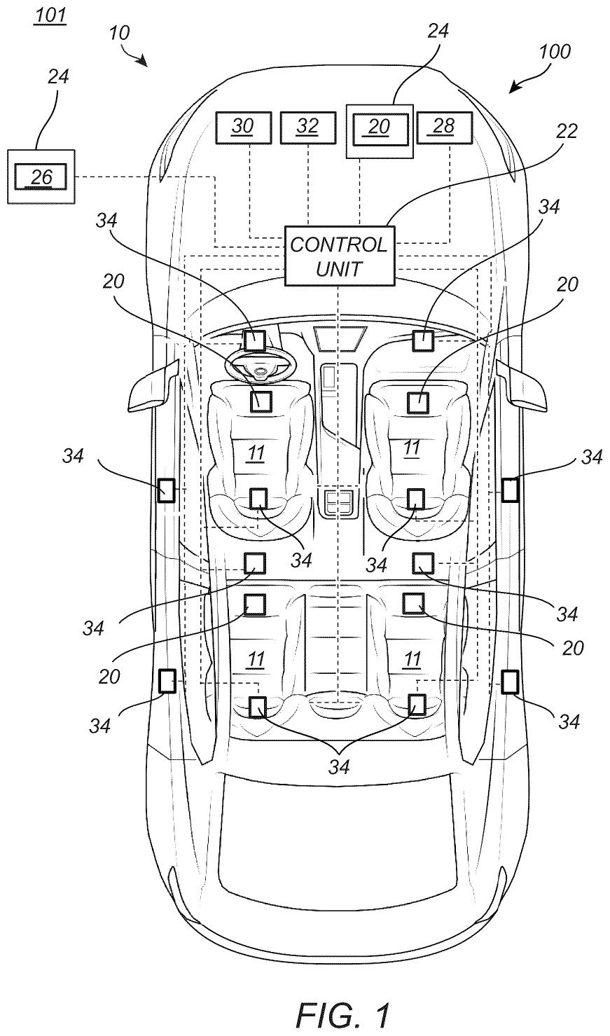

Referring now generally to FIG. 1, a schematic diagram of an exemplary embodiment of a system for assisting a distracted vehicle occupant is illustrated in accordance with aspects of the present subject matter. As shown, a vehicle 10 may generally include system (system 100) for controlling vehicle components (e.g., via a vehicle transmission 28, a vehicle power supply 30, an infotainment unit or system 32, and/or one or more occupant sensors 34 (e.g., internal vehicle cameras, microphones, seat sensors, or the like)) based on the emotional state of one or more occupants of the vehicle 10, (e.g., as indicated by the occupant sensors 34). For example, the system 100 may include one or more occupant sensors 34 (e.g., a microphone and camera for each seat assembly 11 provided in the vehicle 10). In some embodiments, various vehicle components may be controlled based on a determined emotional state of a driver and/or operator of the vehicle 10.

While each seat assembly 11 of FIG. 1 is illustrated with one or more dedicated occupant sensors 34, some vehicles 10 and/or systems 100 may not include an occupant sensor 34 or multiple occupant sensors 34 for each seat assembly 11. For example, only a portion of the seat assemblies 11 may be provided with a dedicated microphone, such as some but not all of the rear seat assemblies 11. In some embodiments, adjacent seat assemblies 11 may share a microphone and/or a camera configured for use with embodiments of the system 100 described herein. Furthermore, at least some of the occupants seated within the vehicle 10, such as the occupant of each seat assembly 11 may have a mobile device 20 (e.g., a cellular phone, tablet, laptop, MP4/MP3 audio device, smart watch, wearable technology, Fitbit®, or the like). Embodiments of the system 100 disclosed herein may utilize the mobile device(s) 20 of the occupant(s) to determine the emotional state(s) of the occupant(s). The mobile device(s) 20 may be communicatively coupled to the vehicle 10, the system 100, and/or an associated control unit 22 via one or more receivers, transmitters, transceivers, or the like suitable to establish a wired or wireless connection (e.g., a local area network connection, a Wi-Fi connection, a Bluetooth connection, or the like). Thus and in such embodiments, the occupant sensor(s) 34 may include one more sensors (e.g., microphones, cameras, or the like) of the mobile device(s) 20 suitable to capture data indicative of the emotional state of the occupant(s) of the vehicle.

In some embodiments, the vehicle 10 may be an electric vehicle having electrical components (e.g., batteries) for propelling the vehicle 10. Alternatively, the vehicle 10 may be configured with a rear-mounted or front-mounted internal combustion engine. In other embodiments, the vehicle 10 may be configured as a hybrid vehicle, which is driven by both a petroleum product (e.g., gas, diesel, jet fuel, and the like) and electrical power. It will be appreciated that the exemplary vehicle(s) 10 depicted and described herein are by way of example only, and, in other exemplary embodiments, the vehicle 10 may have any other suitable configuration, including, for example, any other suitable number of rows of seats, rows of doors, etc. and associated occupant sensors 34 and/or mobile devices 20 provided for some and up to all of the seat assemblies 11. Additionally or alternatively, in other exemplary embodiments, any other suitable power sources may be provided. For example, the vehicle 10 may include a liquid or gaseous hydrogen powered engine, a gas turbine engine, an inboard motor, an outboard motor, etc.

While embodiments of the vehicle 10 herein may be illustrated or described as an automotive vehicle, it should be appreciated that the present disclosure is equally applicable to any other form of transportation (e.g., trains, rotary-wing aircraft, fixed-wing aircraft, boats, busses, ferries, passenger rail cars, public transportation, and the like) where assisting a distracted vehicle occupant (e.g., the driver or operator) based on a determined emotional state of the occupant is desired. Thus, regardless of the type of power train, design, or model of the vehicle(s) 10, the vehicle(s) 10 may include or be utilized with embodiments of the system 100, as described herein.

As shown, the vehicle 10 and/or system 100 may further include the control unit 22 (e.g., an electronic control unit, multiple associated control units, and/or a combination of one or more processing devices and at least one memory or memory device as described herein) communicatively coupled to the occupant sensor(s) 34, the vehicle transmission 28, the vehicle power supply 30, the infotainment unit or system 32, other components or subsystems associated with the vehicle 10 or system 100, and/or the mobile device(s) 20 of one or more of the occupants, such as all of the occupants, and configured to direct operation of one or more of such components in accordance with aspects of the present subject matter. While a single control unit 22 is illustrated in FIG. 1 for simplicity, it should be appreciated that the control unit 22 may include multiple associated control units that together are configured to provide operational control of the vehicle 10; the system 100; components, systems, or subsystems thereof; and/or the mobile device(s) 20.

The control unit 22 may additionally or alternatively facilitate communication between the system 100, the vehicle 10, the occupant sensor(s) 34, the vehicle transmission 28, the vehicle power supply 30, the infotainment unit or system 32, other components or subsystems associated with the vehicle 10 or system 100, and/or the mobile device(s) 20 of one or more of the occupants. Generally, the control unit 22 may be configured to receive data indicative of the emotional state of the occupant(s) of the vehicle (e.g., via the occupant sensor(s) 34), recognize or determine a high emotional state of the occupant(s), determine one or more corrective actions configured to calm the occupant(s), and implement or cause to be implemented the corrective action(s), e.g., via one or more suitable components, systems, or subsystems of the vehicle 10 and/or system 100. Additionally or alternatively, the data indicative of the emotional state of the occupant(s) of the vehicle 10 may be retrieved from the mobile device(s) 20 associated with the occupant. For example, in response to the high emotion state of the occupant(s), the control unit 22 may determine a corrective action (e.g., playing calming or soothing music or ambient sounds) configured to calm the occupant(s) and may implement the corrective action(s) or cause the same to be implemented, e.g., the control unit 22 may communicate a signal to one or more of another control unit, system, or component included or associated with the vehicle 10 and/or system 100 suitable to implement the corrective action(s).

Thus and as shown in FIG. 1., the control unit 22 may provide operational control of the occupant sensor(s) 34, the vehicle transmission 28, the vehicle power supply 30, the infotainment unit or system 32, and/or the mobile device(s) 20 associated with one or more of the occupants of the vehicle 10 and/or may be communicatively coupled with various additional or alternative components of the vehicle 10 and/or system 100 or components associated with the vehicle 10 and/or system 100, as described in more detail below. While some communication links in FIG. 1 may be illustrated as joint communication links, it should be appreciated that one or more components communicatively coupled to the control unit 22, such as all of the components, may have component dedicated communication links (e.g., wireless or wired communication links with the control unit 22).

In some embodiments and as shown, the control unit 22 may include or be communicatively coupled with one or more external devices 24 (such as any of the mobile devices 20 described herein). The external device(s) 24 may communicate inputs to the control unit(s) 22 utilized to control operation of the system 100, the occupant sensor(s) 34, the vehicle transmission 28, the vehicle power supply 30, the infotainment unit or system 32, other components or subsystems associated with the vehicle 10 or system 100, and/or the mobile device(s) 20 associated with one or more of the occupants of the vehicle 10. As also shown in FIG. 1, the external device(s) 24 communicatively coupled to the control unit(s) 22 may include one or more remote servers, processing units, memory devices, computing devices, or the like (e.g., one or remote computing device 26).

By applying an appropriate algorithm in the control unit 22, the system 100 can be integrated with the rest of the vehicle systems, with input from/output to the vehicle transmission 28; the vehicle power supply 30; the infotainment unit or system (infotainment unit 32); one or more of the occupant sensors 34 (e.g., internal occupant sensors and/or external occupant sensors as illustrated), other components, systems, or subsystems of the vehicle 10 and/or system 100; and/or one or more external devices 24, such as the remote computing device(s) 26 and/or mobile device(s) 20, that includes a mobile application and/or a cloud application configured to provide external information to the control unit 22, such as occupant data indicative of the emotional state of the occupant(s) and/or instructions associated with a distraction determination module/method, as described in more detail herein.

In some embodiments, besides controlling the operation of the vehicle 10 and/or system 100 or components, systems, or subsystems thereof, the control unit 22 may also provide useful information to the operator(s), either directly to the infotainment unit 32, such as a display thereof, or the external device(s) 24, such as a user interface thereof. The user interface of the external device(s) 24 and/or the infotainment unit 32 may include one or more buttons, switches, touch screen capability, or the like allowing a user, occupant, passenger, operator, etc. to communicate inputs to the control unit 22 utilized to control operation of the vehicle 10, the system 100, and/or components, systems, or subsystems thereof, such as the vehicle transmission 28, the vehicle power supply 30, the infotainment unit 32, the occupant sensor(s) 34, the mobile device(s) 20, and the like.

As shown, the system 100 and/or vehicle 10 may include one or more seat sensors (e.g., occupant sensor(s) 34), such as one seat sensor associated with each seat assembly 11 of the vehicle 10. Some embodiments of the seat sensor may include a sensor, circuit, or the like suitable to communicate a signal indicative of whether the associated seat assembly 11 is occupied or empty. For example, a suitable seat sensor may be configured to communicate a signal indicating pressure or weight on the seat, which may indicate at occupied seat assembly 11. Additionally or alternatively, a suitable seat sensor may be configured to communicate a signal indicating use of an associated seat belt, which may indicate at occupied seat assembly 11. It should be appreciated that the system 100 may not monitor seat assemblies 11 determined to be empty for distracted and/or emotional occupants.

As shown, the vehicle 10 and/or system 100 may include one or more additional or alternative occupant sensors 34, such as one or more internal occupant sensors 34 associated with each seat 11 of the vehicle 10, as shown, and/or one or more external occupant sensors 34 for each door or entry to the vehicle 10. The occupant sensor(s) 34 may generally be configured to communicate one or more signals indicative of, without limitation, one or more qualities of an occupant seated within an associated seat assembly 11 of the vehicle 10, one or more qualities of a potential occupant about to enter the vehicle 10, and/or one or more qualities of an occupant in the process of being seated in a seat assembly 11. For instance, the occupant sensor(s) 34 may communicate data indicative of, but not limited to, the emotional state(s) of the occupant(s), the voice and/or speech patterns of the occupant(s), emotional language or trigger words utilized by the occupant(s), the facial expressions of the occupant(s), the behavior of the occupant(s) such as erratic movements, or the heart rate of the occupant(s).

The occupant sensor(s) 34 may include, without limitation, one or more microphones, audio sensors, cameras, optical sensors, RADAR sensors, LIDAR sensors, inferred sensors, acoustic sensors, ultrasonic sensors, RFID transceivers/receivers, proximity sensors, a seat sensor (e.g., a weight sensor embedded or provided in association with the seat 11), heart rate sensors (e.g., a heart rate sensor included or integrated with a vehicle steering wheel), other sensors suitable to transmit and/or receive suitable electromagnetic or acoustic signals/waves or the like, and/or other sensors capable of sensing occupant qualities indicative of the emotional state of the occupant(s).

With respect to external embodiments of the occupant sensor(s) 34. Such external occupant sensor(s) 34 may generally be configured to communicate one or more signals indicative of, without limitation, that a potential occupant has approached an associated door of the vehicle 10; one or more qualities of a potential occupant within proximity of the door (e.g., the emotional state(s) of the occupant(s), the voice and/or speech patterns of the occupant(s), emotional language or trigger words utilized by the occupant(s), the facial expressions of the occupant(s), or the behavior of the occupant(s) such as erratic movements).

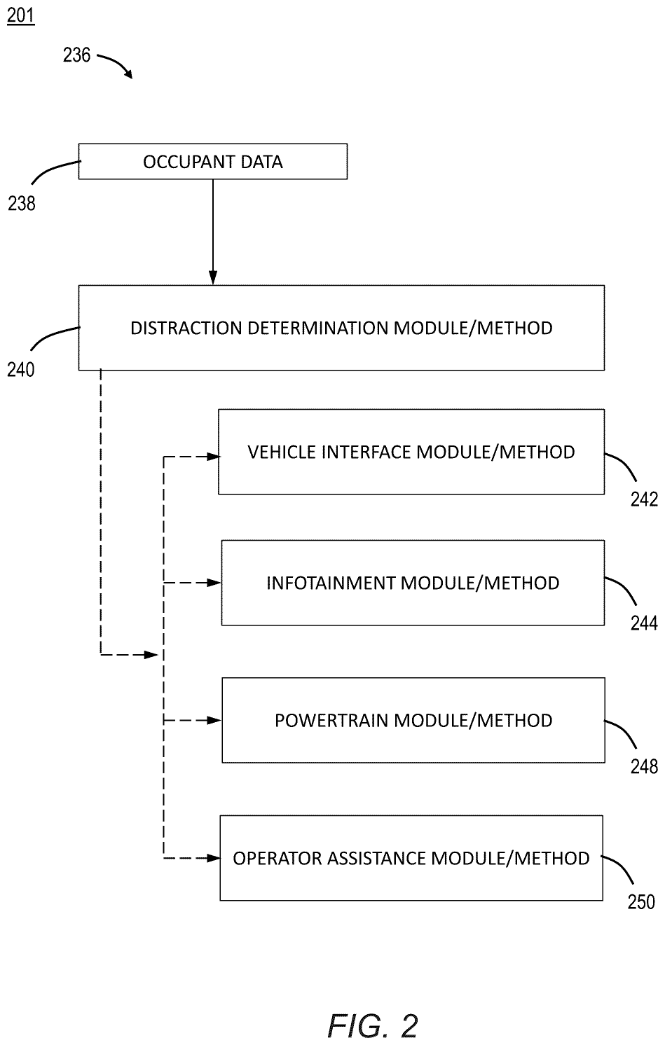

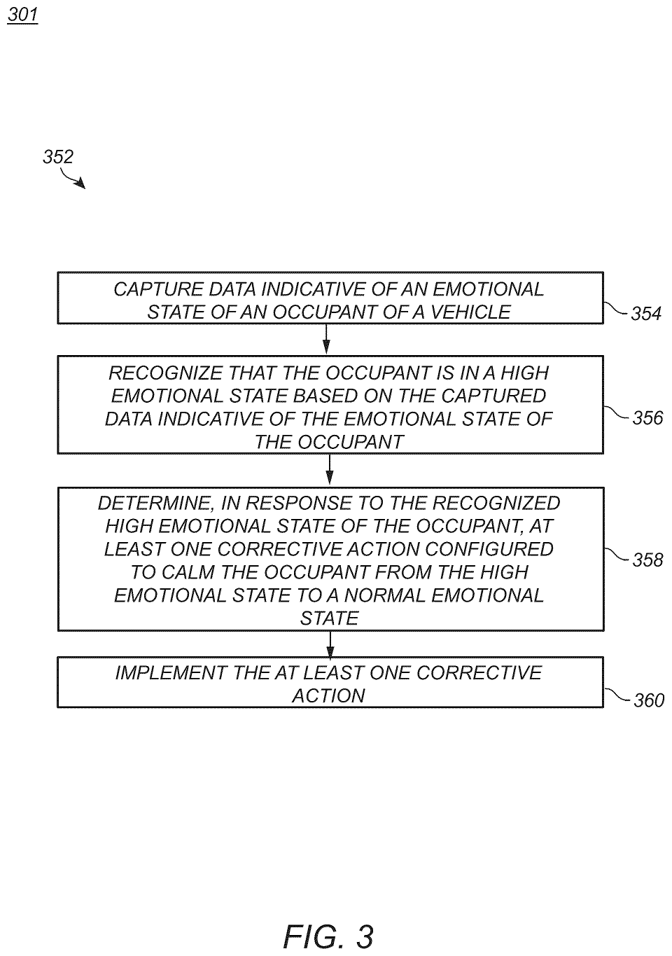

Referring now to FIGS. 2-3, FIG. 2 illustrates a schematic logic diagram of an exemplary embodiment of a system for assisting a distracted vehicle occupant, in accordance with aspects of the present subject matter, and FIG. 3 illustrates one exemplary embodiment of a method for assisting a distracted vehicle occupant, in accordance with aspects of the present disclosure. The logic diagram depicted in FIG. 2 (control logic 236) and/or the method or process (method 352) depicted in FIG. 3 may be utilized to control or in association with embodiments of the vehicle 10, the system 100, the occupant sensor(s) 34, the vehicle transmission 28, the vehicle power supply 30, the infotainment unit 32, other components or subsystems associated with the vehicle 10 or system 100, and/or the mobile device(s) 20 of the occupants, as described with respect to FIG. 1 and/or other similar or suitably configured vehicles, systems for assisting a distracted vehicle occupant, or components, systems, or subsystems thereof. The control logic 236 may include one or more modules including instructions stored in at least one memory and executable by one or more processors to cause the processor(s) to implement steps, method elements, or the like as described herein. For example, elements of the control logic 236 and/or method 352 may be implemented, at least in part, by the control unit 22 and stored in memory associated with the control unit 22 and/or included with or accessible by the vehicle 10.

As shown, the control logic 236 may include a distraction determination module and/or method (distraction module 240) configured to recognize vehicle occupant(s) in the high-emotional state, to determine one or more corrective actions to calm the occupant(s), and/or to implement or cause to be implemented the corrective actions(s). The determination of the high emotional state of the occupant(s) and/or the corrective action(s) configured to calm the occupant(s) may be based on data indicative of one or more occupant qualities (e.g., occupant data 238) of an occupant seated in, about to be seated in, and/or associated with a seat assembly 11 of the vehicle 10. The method 352 may include and/or the distraction module 240 may be configured to capture data indicative of an emotional state of an occupant of a vehicle, see e.g., method element 354.

Additionally or alternatively, the distraction module 240 may receive the occupant data 238 indicative of a one or more occupants seated within the vehicle 10. The method 352 may include and/or the determine module 240 may be configured to determine, based on the received occupant data 238, a number of occupants seated within the vehicle 10. In some situations and/or embodiments, occupant data 238 may include an indication that the system 100 and/or control unit 22 has been communicatively coupled to one or more mobile devices 20 of the occupant(s). The coupling of the control unit 22 with the mobile device(s) 20 may indicate, at least, a minimum number of occupants of the vehicle 10 and/or position(s) of the associated occupant(s) within the vehicle 10 (e.g., for a wired connection between the system 100/vehicle 10 and the mobile device(s) 20). It should be appreciated that only the seat assemblies 11 that are occupied need to be monitored for an emotional and/or distracted occupant, at least in some embodiments.

In some embodiments of the control logic 236 and/or method 352, the occupant data 236 may be communicated from one or more of the occupant sensors 34 (e.g., one or more internal occupant sensors and/or external occupant sensors), as described herein, and/or the external device(s) 24 (e.g., the remote computing device(s) 26, mobile device(s) 20, and/or other suitably configured external computing device(s) that include a mobile application and/or a cloud application configured to provide external information to the control unit 22). The method 352 may include and/or the distraction module 240 may be configured to recognize that the occupant(s) is/are in a high emotional state based on the captured data indicative of the emotional state of the occupant(s), see method element 358. Additionally or alternatively, the emotional state(s) of the occupant(s) may be recognized, determined, or the like utilizing one or more artificial intelligence algorithms and based on the occupant data 238. Thus, the distraction module 240 and/or associated method 352 may include or be associated with one or more artificial intelligence algorithms.

In some embodiments, the high emotional state recognized or determined via the distraction module 240, method 352, and/or the associated artificial intelligence algorithm(s) may be associated with one or more of occupant speech over a predetermined db level, an argument involving the occupant(s) (e.g., between occupants or an occupant and a remote person), the use of one or more curse words or phrases (e.g., trigger words associated with a high emotional state) by the occupant(s), an emotional facial expression of the occupant(s), crying of the occupant(s), red or puffy eyes of the occupant(s), increased nasal mucous production of the occupant(s), erratic movement of the occupant(s) (e.g., banging on the steering wheel or dash), a heart rate of the occupant(s) over a predetermined threshold, increased sweating of the occupant(s), or use or repeated use of a horn of the vehicle 10. Thus, the high emotional state of the occupant(s) may be determined utilizing the occupant data 238 indicative of the qualities of the occupant(s) and/or sensed by one or more of the occupant sensors 34 described herein. The occupant data 238 may generally be indicative of one or more qualities of the occupant(s) seated within the associated seat assembly(ies) 11 of the vehicle 10, about to enter the vehicle 10, and/or one in the process of being seated in respective seat assemblies 11 of the vehicle 10.

The artificial intelligence algorithms(s) may include one or more algorithms, programs, modules, and the like suitable to simulate intelligence human behavior or perform tasks historically requiring human implementation. For example, the artificial intelligence algorithms may include, without limitation, one or more of machine learning algorithms, artificial neural networks, recurrent artificial neural networks, feedforward neural networks, convolutional neural networks, recurrent neural networks, deep neural networks, natural language processing algorithms, long short term memory networks, inductive logic programming algorithms, support vector machines, clustering algorithms, Bayesian networks, reinforcement learning algorithms, representation learning algorithms, similarity and metric learning algorithms, sparse dictionary learning algorithms, genetic algorithms, k-nearest neighbor (KNN) algorithms, decision tree learning algorithms, association rule learning algorithms, and the like. Some of the artificial intelligence algorithms described herein may be trained (via a supervised or unsupervised training process) based on training data provided to the artificial intelligence algorithms. Thus, the artificial intelligence algorithm(s) may generally be utilized to determine the number of occupants in the vehicle 10, the positions of the occupants of the vehicle 10, and/or the emotional state of each occupant of the vehicle 10 based at least in part on the occupant data 238 indicative of the occupant quality(ies).

In some embodiments, the distraction module 240 and/or method 352 may include receiving the occupant data 238 and/or a signal indicative of the qualities of the occupant(s) of the vehicle 10 at a first predetermined time interval prior to recognizing that the occupant(s) is in the high emotional state, as described herein. Thus and in such embodiments, the occupant data 238 or updates to the occupant data 238 may be provided to the control unit 22 and/or the distraction module 240 to determine the emotional state(s) of the occupant(s) at the first predetermined interval (e.g., at least every minute or at least every 30 seconds) while the occupant(s) are in a normal emotional state.

Additionally or alternatively, the distraction module 240 and/or method 352 may include receiving the occupant data 238 and/or a signal indicative of the qualities of the occupant(s) of the vehicle 10 from a first occupant sensor 34 or first type of occupant sensor(s) 34 prior to recognizing that the occupant(s) is in the high emotional state, as described herein. Thus and in such embodiments, the occupant data 238 or updates to the occupant data 238 sensed or captured by the first occupant sensor 34 and/or first type of occupant sensors 34 may be provided to the control unit 22 and/or the distraction module 240 to determine the emotional state(s) of the occupant(s) while the occupant(s) are in a normal emotional state. For example, the first occupant sensor 34 or first type of occupant sensors 34 may include one or more microphones, audio sensors, or the like. Alternatively, the first occupant sensor 34 or first type of occupant sensor 34 may include one or more cameras or visual sensors. Thus, it should be appreciated that one of sound or visual occupant data 238 may be utilized to recognize or determine a change to the high emotional state of the occupant(s) while in the normal emotional state.

Thus, resources may be conserved by more minimally monitoring the occupant(s) while the occupant(s) is/are in the normal emotional state. For example, the occupant sensor(s) 34 may only be activated (e.g., from an off or standby setting) when actively communicating the occupant data 238 and/or a signal indicative of the emotional state(s) of the occupant(s). Subsequent to determining the high emotional state of the occupant(s), more resources may be allocated to confirming the high emotional state of the occupant(s) and/or the emotional state of the occupant(s) can be recognized or determined more often until the emotional state of the occupant(s) returns to the normal emotional state. In at least one example and configuration, the distraction module 240 and/or method 352 may include receiving the occupant data 238 and/or a signal indicative of the qualities of the occupant(s) of the vehicle 10 at a second predetermined time interval after recognizing that the occupant(s) is in the high emotional state, as described herein, and until the occupant(s) return to the normal emotional state. The second predetermined time interval is generally shorter than the first predetermined time interval. For example, the occupant data 238 or updates to the occupant data 238 may be provided to the control unit 22 and/or the distraction module 240 to determine the emotional state(s) of the occupant(s) at the second predetermined interval (e.g., at least 10 seconds, at least every 5 seconds, at least every 1 second, etc.) while one or more of the occupants are recognized or determined to be in the high emotional state.

Additionally or alternatively, the distraction module 240 and/or method 352 may include receiving the occupant data 238 and/or a signal indicative of the qualities of the occupant(s) of the vehicle 10 from a second occupant sensor 34 or type of occupant sensor(s) 34 after recognizing that the occupant(s) is in the high emotional utilizing the first occupant sensor 34 or first type of occupant sensor(s) 34. Generally, the first occupant sensor 34 or first type of occupant sensor(s) 34 is different than the second occupant sensor 34 or second type of occupant sensor(s) 34. For example and in some such embodiments, the occupant data 238 or updates to the occupant data 238 sensed or captured by the first occupant sensor 34 and/or first type of occupant sensor(s) 34 and second occupant sensor 34 and/or second type of occupant sensor(s) 34 may be provided to the control unit 22 and/or the distraction module 240 to determine the emotional state(s) of the occupant(s) while one or more of the occupants are in the high emotional state. For example, the second occupant sensor 34 or second type of occupant sensors 34 may include one or more cameras, visual sensors, or the like. Alternatively, the second occupant sensor 34 or second type of occupant sensor 34 may include one or more microphones, audio sensors, or the like. Thus, it should be appreciated that both of sound and visual occupant data 238 may be utilized to recognize or determine the emotional state(s) of the occupant(s) while one or more occupant(s) are recognized or determined to be in the high emotional state. While the above examples are described with respect to cameras/visual sensors and microphones/audio sensors, it should be appreciated that the first occupant sensor 34 or type of first occupant sensor(s) 34 and the second occupant sensor or type of second occupant sensor(s) 34 may include any different occupant sensors 34 or types of occupant sensors 34 as described here. For example, the second occupant sensor 34 or type of occupant sensors 34 may include a heart rate sensor such that the heart rate of an occupant in the high emotional state can be monitored until the occupant returns to the normal emotional state.

Referring still to FIGS. 2-3, the method 352 may include and/or the distraction module 240 may be configured to determine one or more corrective actions configured to calm the occupant(s) in high emotional state to the normal emotional state in response to recognizing the high emotional state of the occupant(s), see method element 358. Additionally or alternatively, the corrective action(s) may be determined based on the occupant data 238 and/or one or more artificial intelligence algorithms included or associated with the distraction module 240 and/or method 352. The corrective action(s) may include one or more of playing soothing ambient sounds or music within the vehicle 10, turning off a sound system of the vehicle 10, activating a driver assistance system of the vehicle 10, activating an autonomous driving system of the vehicle 10, alerting the occupant(s) of the vehicle 10 of the high emotional state, reducing a sensitivity of one or more vehicle controls, preventing use of a mobile device(s) 20 of the occupant(s), reducing a travel speed or a maximum speed of the vehicle 10, or establishing a communication link between the occupant(s) and assistance (e.g., emergency medical personal, a suicide hotline, a real mediator or therapist, a virtual mediator or therapist, or the like).

Furthermore or alternatively, the method 352 may include and/or the distraction module 240 may be configured to implement or cause to be implemented the corrective action(s), see method element 360. For example and in some embodiments, the distraction module 240 and/or control unit 22 may provide operational control or communicate one or more signals to cause one or more suitably configured components of the vehicle 10 and/or system 100 to implement the corrective action(s). Additionally or alternatively, causing the corrective action(s) to be implemented may include communicating a signal to one or more of a subsystem of the system 100, another module of the system 100, or another system of the vehicle 10 suitable to implement the corrective action(s).

For example and as shown in FIG. 2, the distraction module 240 may be communicatively coupled to a vehicle interface module/method 242 configured to implement one or more of the potential corrective actions (e.g., reducing a sensitivity of the vehicle controls such as a pedal controller, a steering wheel controller, or the like). In a further or different example, the distraction module 240 may be communicatively coupled to an infotainment module/method 244 configured to implement one or more of the potential corrective actions (e.g., playing soothing ambient sounds or music within the vehicle 10, turning off a sound system of the vehicle 10, alerting the occupant(s) of the vehicle 10 of the high emotional state, preventing use of a mobile device(s) 20 of the occupant(s), establishing a communication link between the occupant(s) and assistance, or the like). In a further or different example, the distraction module 240 may be communicatively coupled to a powertrain module/method 248 configured to implement one or more of the potential corrective actions (e.g., reducing a maximum speed of the vehicle 10 such as a setting of a speed limiter, preventing downshifting of the vehicle transmission 10, reducing a maximum revolutions per minute (RPM) or power/torque output of the vehicle power supply 30, or the like). In a still further or different example, the distraction module 240 may be communicatively coupled to an operator assistance module/method 250 configured to implement one or more potential corrective actions (e.g., activating a driver assistance system of the vehicle 10, activating an autonomous driving system of the vehicle 10, reducing a travel speed of the vehicle 10 such as via a cruise control setting, or the like). The modules discussed above and included in FIG. 2 are provided for example only, and it should be appreciated that the distraction module 240 may provide communicated instructions to any other modules, subsystems, or systems associated with the vehicle 10 and/or system 100 suitable to implement one or more of the corrective actions.

Subsequent to implementation of the corrective action(s), the method 352 may include and/or the distraction module 240 may be configured to capture again and/or to receive updated captured data (e.g., updated occupant data 238 and/or data or signals communicated from the occupant sensor(s) 34) indicative of updated emotional state(s) of the occupant(s) of the vehicle 10. The method 352 may include and/or the distraction module 240 may be configured to recognize that the occupant(s) is/are in the normal emotional state based on the updated captured data (e.g., updated occupant data 238) indicative of the updated emotional state of the occupant(s). For example, one or more artificial intelligence algorithms may be configured to recognize that the occupant(s) previously in the high emotional state have returned to the normal emotional state, similar to the initial determination of the high emotional state. In response to the recognition that the occupant(s) are all in or have returned to the normal emotional state, the method 352 may include and/or the distraction module 240 may be configured to terminate or cause to be terminated the corrective action(s).

Additionally or alternatively, for some embodiments, the method 352 may include and/or the distraction module 240 may be configured to recognize that the occupant(s) is/are still in the high emotional state based on the updated captured data (e.g., updated occupant data 238) indicative of the updated emotional state(s) of the occupant(s). For example, one or more artificial intelligence algorithms may be configured to recognize that the occupant(s) previously in the high emotional state are still in the high emotional state, similar to the initial determination of the high emotional state. Additionally or alternatively, the method 352 may include and/or the distraction module 240 (or one or more associated artificial intelligence algorithms) may be configured to determine one or more additional corrective actions configured to calm the occupant(s) from the high emotional state to the normal emotional state, similar to the determination of the initial corrective actions. Furthermore, the method 352 may include and/or the distraction module 240 may be configured to implement or cause to be implemented the additional corrective action(s) similar to the implementation of the initial corrective action(s). This process may generally be repeated until the occupant(s) return to or are all in the normal emotional state. Thus, potential corrective actions may be incrementally implemented until the occupant(s) return to the normal emotional state. For example, if reducing the volume of music or playing calming music is not sufficient to return the occupant(s) to the normal emotional state, the sound system may be turned off. If turning off the sound system is not enough to return the occupant(s) to the normal emotional state, vehicle control interfaces may be deadened, autonomous driving may be implemented, or the like until the occupant(s) return to the normal emotional state.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

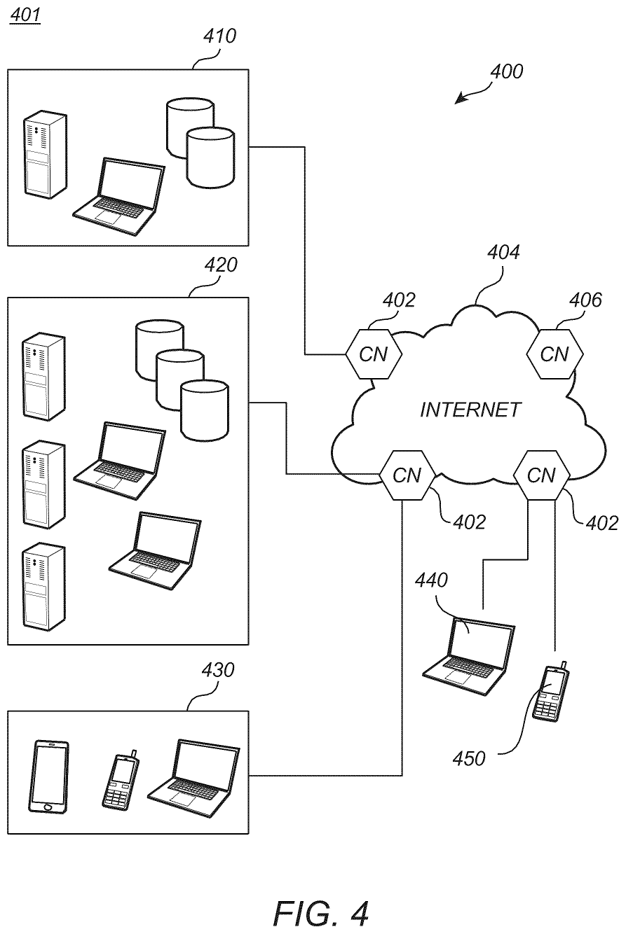

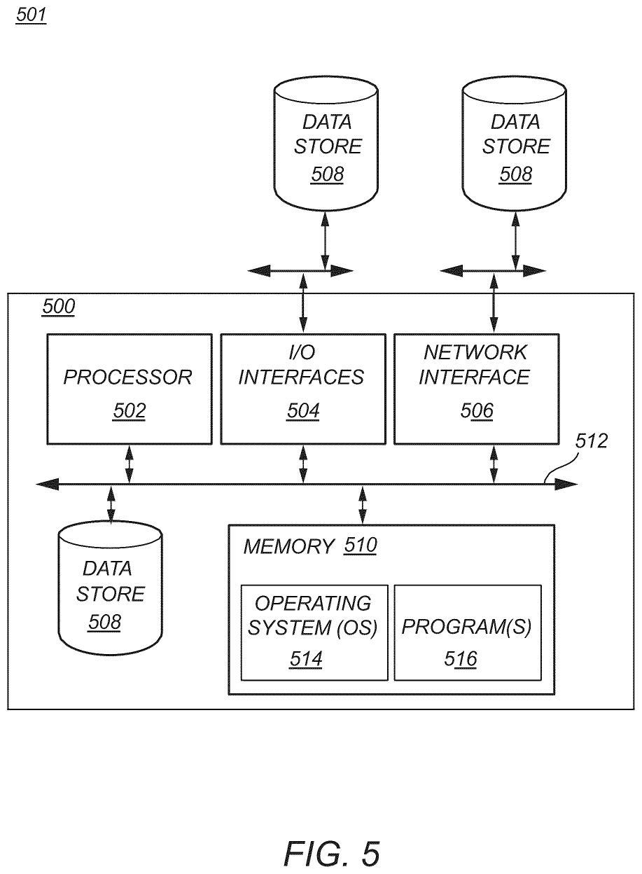

FIG. 4 is a network diagram of a cloud-based system 400 for implementing various cloud-based services of the present disclosure. The cloud-based system 400 includes one or more cloud nodes (CNs) 402 communicatively coupled to the Internet 404 or the like. The cloud nodes 402 may be implemented as a server 500 (as illustrated in FIG. 5) or the like and can be geographically diverse from one another, such as located at various data centers around the country or globe. Further, the cloud-based system 400 can include one or more central authority (CA) nodes 406, which similarly can be implemented as the server 400 and be connected to the CNs 402. For illustration purposes, the cloud-based system 400 can connect to a regional office 410, headquarters 420, various employee's homes 430, laptops/desktops 440, and mobile devices 450, each of which can be communicatively coupled to one of the CNs 402. These locations 410, 420, and 430, and devices 440 and 450 are shown for illustrative purposes, and those skilled in the art will recognize there are various access scenarios to the cloud-based system 400, all of which are contemplated herein. The devices 440 and 450 can be so-called road warriors, i.e., users off-site, on-the-road, etc. The cloud-based system 400 can be a private cloud, a public cloud, a combination of a private cloud and a public cloud (hybrid cloud), or the like.

Again, the cloud-based system 400 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 410, 420, and 430 and devices 440 and 450. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 400 is replacing the conventional deployment model. The cloud-based system 400 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 400 is illustrated herein as one example embodiment of a cloud-based system, and those of ordinary skill in the art will recognize the systems and methods described herein are not necessarily limited thereby.

FIG. 5 is a block diagram of a server 500, which may be used in the cloud-based system 400 (FIG. 4), in other systems, or stand-alone. For example, the CNs 402 (FIG. 4) and the central authority nodes 406 (FIG. 4) may be formed as one or more of the servers 500. The server 500 may be a digital computer that, in terms of hardware architecture, generally includes a processor 502, input/output (I/O) interfaces 504, a network interface 506, a data store 508, and memory 510. It should be appreciated by those of ordinary skill in the art that FIG. 5 depicts the server 500 in an oversimplified manner, and a practical embodiment may include additional components and suitably configured processing logic to support known or conventional operating features that are not described in detail herein. The components (502, 504, 506, 508, and 510) are communicatively coupled via a local interface 512. The local interface 512 may be, for example, but is not limited to, one or more buses or other wired or wireless connections, as is known in the art. The local interface 512 may have additional elements, which are omitted for simplicity, such as controllers, buffers (caches), drivers, repeaters, and receivers, among many others, to enable communications. Further, the local interface 512 may include address, control, and/or data connections to enable appropriate communications among the aforementioned components.

The processor 502 is a hardware device for executing software instructions. The processor 502 may be any custom made or commercially available processor, a central processing unit (CPU), an auxiliary processor among several processors associated with the server 500, a semiconductor-based microprocessor (in the form of a microchip or chipset), or generally any device for executing software instructions. When the server 500 is in operation, the processor 502 is configured to execute software stored within the memory 510, to communicate data to and from the memory 510, and to generally control operations of the server 500 pursuant to the software instructions. The I/O interfaces 504 may be used to receive user input from and/or for providing system output to one or more devices or components.

The network interface 506 may be used to enable the server 500 to communicate on a network, such as the Internet 404 (FIG. 4). The network interface 506 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 506 may include address, control, and/or data connections to enable appropriate communications on the network. A data store 508 may be used to store data. The data store 508 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 508 may incorporate electronic, magnetic, optical, and/or other types of storage media. In one example, the data store 508 may be located internal to the server 500, such as, for example, an internal hard drive connected to the local interface 512 in the server 500. Additionally, in another embodiment, the data store 508 may be located external to the server 500 such as, for example, an external hard drive connected to the I/O interfaces 504 (e.g., a SCSI or USB connection). In a further embodiment, the data store 508 may be connected to the server 500 through a network, such as, for example, a network-attached file server.

The memory 510 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 510 may have a distributed architecture, where various components are situated remotely from one another but can be accessed by the processor 502. The software in memory 510 may include one or more software programs, each of which includes an ordered listing of executable instructions for implementing logical functions. The software in the memory 510 includes a suitable operating system (O/S) 514 and one or more programs 516. The operating system 514 essentially controls the execution of other computer programs, such as the one or more programs 516, and provides scheduling, input-output control, file and data management, memory management, and communication control and related services. The one or more programs 516 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

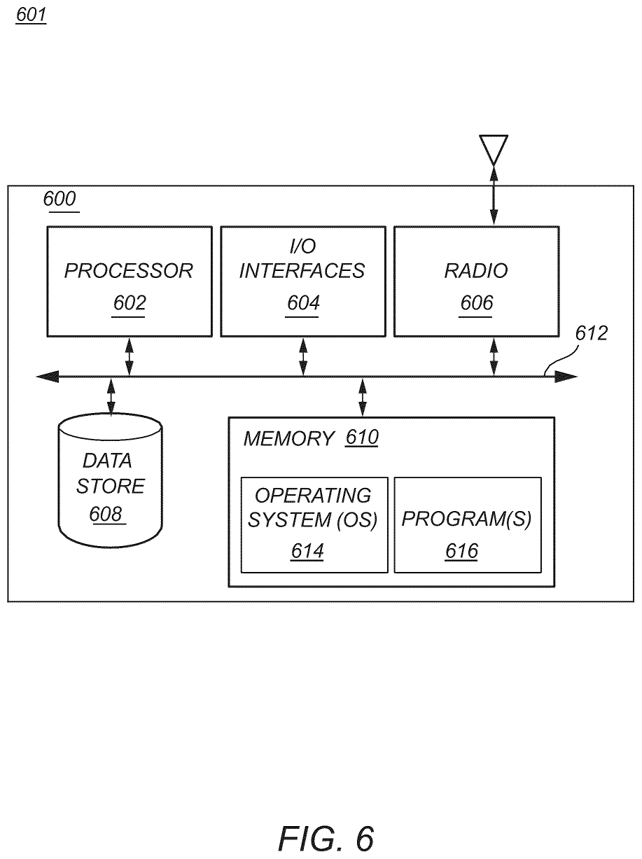

FIG. 6 is a block diagram of a user device 600, which may be used in the cloud-based system 400 (FIG. 4), as part of a network, or stand-alone. Again, the user device 600 can be a vehicle (e.g., one or more control units thereof), a smartphone, a tablet, a smartwatch, an Internet of Things (IoT) device, a laptop, a virtual reality (VR) headset, etc. The user device 600 can be a digital device that, in terms of hardware architecture, generally includes a processor 602, I/O interfaces 604, a radio 606, a data store 608, and memory 610. It should be appreciated by those of ordinary skill in the art that FIG. 6 depicts the user device 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 can be, for example, but is not limited to, one or more buses or other wired or wireless connections, as is known in the art. The local interface 612 can have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 can be any custom made or commercially available processor, a CPU, an auxiliary processor among several processors associated with the user device 600, a semiconductor-based microprocessor (in the form of a microchip or chipset), or generally any device for executing software instructions. When the user device 600 is in operation, the processor 602 is configured to execute software stored within the memory 610, to communicate data to and from the memory 610, and to generally control operations of the user device 600 pursuant to the software instructions. In an embodiment, the processor 602 may include a mobile optimized processor such as optimized for power consumption and mobile applications. The I/O interfaces 604 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 606 enables wireless communication to an external access device or network. Any number of suitable wireless data communication protocols, techniques, or methodologies can be supported by the radio 606, including any protocols for wireless communication. The data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media.

Again, the memory 610 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 610 may incorporate electronic, magnetic, optical, and/or other types of storage media. Note that the memory 610 may have a distributed architecture, where various components are situated remotely from one another, but can be accessed by the processor 602. The software in memory 610 can include one or more software programs, each of which includes an ordered listing of executable instructions for implementing logical functions. In the example of FIG. 6, the software in the memory 610 includes a suitable operating system 614 and programs 616. The operating system 614 essentially controls the execution of other computer programs and provides scheduling, input-output control, file and data management, memory management, and communication control and related services. The programs 616 may include various applications, add-ons, etc. configured to provide end user functionality with the user device 600. For example, example programs 616 may include, but not limited to, a web browser, social networking applications, streaming media applications, games, mapping and location applications, electronic mail applications, financial applications, and the like. In a typical example, the end-user typically uses one or more of the programs 616 along with a network, such as the cloud-based system 400 (FIG. 4).

Again, embodiments of the disclosed systems and methods facilitate first sensing an angry, disturbed, or even suicidal driver or occupant using internal cameras, microphones, and sensors and a variety of artificial intelligence algorithms, for example. These sensors sense loud speech and arguments (between occupants, between a driver and someone on a mobile device, etc.) and hostile facial expressions and other movements, for example, sensing anything that indicates a heightened emotional state by any available means. Once detected, vehicle sensors may be tuned for enhanced detection, soothing ambient sounds/music may be provided, pilot assist may be instituted, progressive safety alerts may be provided, vehicle controls may be deadened, autonomous control may be implemented, mobile devices may be disabled, etc., such that the driver and others in the vehicle may be calmed and made more responsive to ensure the occupants' and surrounding's safety. In a detected suicide case, autonomous control may be implemented, and a link to assistance may be initiated. In this sense, the vehicle may act as a virtual mediator/therapist until a safe vehicle operation situation is restored, with a calm, attentive driver.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following, non-limiting Clauses and/or Claims for all purposes.

Clause 1: A vehicle comprising:
a system for providing assisting a distracted vehicle occupant, the system comprising a distraction determination module.

Clause 2: The vehicle of any one of the previous clauses, further comprising a first occupant sensor configured to capture data indicative of an emotional state of an occupant of the vehicle.

Clause 3: A system for assisting a distracted vehicle occupant, the system comprising a distraction determination module.

Clause 4: The system of any one of the previous clauses, the system further comprising a first occupant sensor configured to capture data indicative of an emotional state of an occupant of the vehicle.

Clause 5: The system of any one of the previous clauses, wherein the distraction determination module comprises instructions stored in at least one memory and executable by one or more processors to cause the distraction determination module to recognize that the occupant is in a high emotional state based on the captured data indicative of the emotional state of the occupant.

Clause 6: The system of any one of the previous clauses, wherein the distraction determination module comprises instructions stored in at least one memory and executable by one or more processors to cause the distraction determination module to determine, in response to the recognized high emotional state of the occupant, at least one corrective action configured to calm the occupant from the high emotional state to a normal emotional state.

Clause 7: The system of any one of the previous clauses, wherein the distraction determination module comprises instructions stored in at least one memory and executable by one or more processors to cause the distraction determination module to implement or cause to be implemented the at least one corrective action.

Clause 8: The system of any one of the previous clauses, wherein the occupant comprises a driver or operator of the vehicle.

Clause 9: The system of any one of the previous clauses, wherein the high emotional state is associated with occupant speech over a predetermined db level.

Clause 10: The system of any one of the previous clauses, wherein the high emotional state is associated with an argument involving the occupant.

Clause 11: The system of any one of the previous clauses, wherein the high emotional state is associated with use of at least one trigger word by the occupant.

Clause 12: The system of any one of the previous clauses, wherein the high emotional state is associated with an emotional facial expression of the occupant.

Clause 13: The system of any one of the previous clauses, wherein the high emotional state is associated with an erratic movement of the occupant.

Clause 14: The system of any one of the previous clauses, wherein the high emotional state is recognized utilizing an artificial intelligence algorithm.

Clause 15: The system of any one of the previous clauses, wherein the at least one corrective action comprises playing soothing ambient sounds or music.

Clause 16: The system of any one of the previous clauses, wherein the at least one corrective action comprises turning off a sound system of the vehicle.

Clause 17: The system of any one of the previous clauses, wherein the at least one corrective action comprises activating a driver assistance system of the vehicle.

Clause 18: The system of any one of the previous clauses, wherein the at least one corrective action comprises activating an autonomous driving system of the vehicle.

Clause 19: The system of any one of the previous clauses, wherein the at least one corrective action comprises alerting the occupant of the vehicle of the high emotional state.

Clause 20: The system of any one of the previous clauses, wherein the at least one corrective action comprises reducing a sensitivity of at least one vehicle control.

Clause 21: The system of any one of the previous clauses, wherein the at least one corrective action comprises preventing use of a mobile device of the occupant.

Clause 22: The system of any one of the previous clauses, wherein the at least one corrective action comprises reducing a travel speed of the vehicle.

Clause 23: The system of any one of the previous clauses, wherein the at least one corrective action comprises reducing a maximum speed of the vehicle.

Clause 24: The system of any one of the previous clauses, wherein the at least one corrective action comprises establishing a communication link between the occupant and assistance.

Clause 25: The system of any one of the previous clauses, wherein causing the at least one corrective action to be implemented comprises communicating a signal to at least one of a subsystem of the system, another module of the system, or another system of the vehicle suitable to implement the at least one corrective action.

Clause 26: The system of any one of the previous clauses, wherein the distraction determination module further comprises instructions stored in the at least one memory and executable by the one or more processors to cause the distraction determination module to receive the captured data indicative of the emotional state of the occupant of the vehicle at a first predetermined time interval prior to recognizing that the occupant is in the high emotional state.

Clause 27: The system of any one of the previous clauses, wherein the distraction determination module further comprises instructions stored in the at least one memory and executable by the one or more processors to cause the distraction determination module to receive, in response to the recognized high emotional state of the occupant, the captured data indicative of the emotional state of the occupant at a second predetermined time interval, the second predetermined time interval shorter than the first predetermined time interval.

Clause 28: The system of any one of the previous clauses, further comprising a second occupant sensor, different than the first occupant sensor, also configured to capture the data indicative of the emotional state of the occupant of the vehicle.

Clause 29: The system of any one of the previous clauses, wherein the distraction determination module further comprises instructions stored in the at least one memory and executable by the one or more processors to cause the distraction determination module to receive the captured data indicative of the emotional state of the occupant of the vehicle from the first occupant sensor but the not the second occupant sensor prior to recognizing that the occupant is in the high emotional state.

Clause 30: The system of any one of the previous clauses, wherein the distraction determination module further comprises instructions stored in the at least one memory and executable by the one or more processors to cause the distraction determination module to receive, in response to the recognized high emotional state of the occupant, the captured data indicative of the emotional state of the occupant of the vehicle from the first occupant sensor and the second occupant sensor.

Clause 31: The system of any one of the previous clauses, wherein the first occupant sensor comprises an audio sensor or a microphone.

Clause 32: The system of any one of the previous clauses, wherein the second occupant sensor comprises a visual sensor or camera.

Clause 33: The system of any one of the previous clauses, wherein the first occupant sensor comprises a visual sensor or camera.

Clause 34: The system of any one of the previous clauses, wherein the second occupant sensor comprises an audio sensor or a microphone.

Clause 35: The system of any one of the previous clauses, wherein the distraction determination module further comprises instructions stored in the at least one memory and executable by the one or more processors to cause the distraction determination module to receive updated captured data indicative of an updated emotional state of the occupant of the vehicle subsequent to implementation of the at least one corrective action.

Clause 36: The system of any one of the previous clauses, wherein the distraction determination module further comprises instructions stored in the at least one memory and executable by the one or more processors to cause the distraction determination module to recognize that the occupant is in a normal emotional state based on the updated captured data indicative of the updated emotional state of the occupant.

Clause 37: The system of any one of the previous clauses, wherein the distraction determination module further comprises instructions stored in the at least one memory and executable by the one or more processors to cause the distraction determination module to terminate or cause to be terminated the at least one corrective action.

Clause 38: The system of any one of the previous clauses, wherein the distraction determination module further comprises instructions stored in the at least one memory and executable by the one or more processors to cause the distraction determination module to recognize that the occupant is still in the high emotional state based on the updated captured data indicative of the updated emotional state of the occupant.

Clause 39: The system of any one of the previous clauses, wherein the distraction determination module further comprises instructions stored in the at least one memory and executable by the one or more processors to cause the distraction determination module to determine, in response to recognizing that the occupant is still in the high emotional state, at least one additional corrective action configured to calm the occupant from the high emotional state to the normal emotional state.

Clause 40: The system of any one of the previous clauses, wherein the distraction determination module further comprises instructions stored in the at least one memory and executable by the one or more processors to cause the distraction determination module to implement or cause to be implemented the at least one additional corrective action.

Clause 41: The system of any one of the previous clauses, further comprising a non-transitory computer-readable medium comprising instructions stored in at least one memory that, when executed by one or more processors, cause the one or more processors to carry out steps.

Clause 42: A method for assisting a distracted vehicle occupant utilizing the system of any of the previous clauses.

Clause 43: A non-transitory computer-readable medium comprising instructions stored in at least one memory that, when executed by one or more processors, cause the one or more processors to carry out steps.

Clause 44: The non-transitory computer-readable medium of any one of the previous clauses, wherein the steps comprise capturing data indicative of an emotional state of an occupant of a vehicle.

Clause 45: The non-transitory computer-readable medium of any one of the previous clauses, wherein the steps comprise recognizing that the occupant is in a high emotional state based on the captured data indicative of the emotional state of the occupant.

Clause 46: The non-transitory computer-readable medium of any one of the previous clauses, wherein the steps comprise determining, in response to the recognized high emotional state of the occupant, at least one corrective action configured to calm the occupant from the high emotional state to a normal emotional state.

Clause 47: The non-transitory computer-readable medium of any one of the previous clauses, wherein the steps comprise implementing the at least one corrective action.

Clause 48: The non-transitory computer-readable medium of any one of the previous clauses, wherein the occupant comprises a driver or operator of the vehicle.

Clause 49: The non-transitory computer-readable medium of any one of the previous clauses, wherein the high emotional state is associated with occupant speech over a predetermined db level.

Clause 50: The non-transitory computer-readable medium of any one of the previous clauses, wherein the high emotional state is associated with an argument involving the occupant.

Clause 51: The non-transitory computer-readable medium of any one of the previous clauses, wherein the high emotional state is associated with use of at least one trigger word by the occupant.

Clause 52: The non-transitory computer-readable medium of any one of the previous clauses, wherein the high emotional state is associated with an emotional facial expression of the occupant.

Clause 53: The non-transitory computer-readable medium of any one of the previous clauses, wherein the high emotional state is associated with an erratic movement of the occupant.

Clause 54: The non-transitory computer-readable medium of any one of the previous clauses, wherein the at least one corrective action comprises playing soothing ambient sounds or music.

Clause 55: The non-transitory computer-readable medium of any one of the previous clauses, wherein the at least one corrective action comprises turning off a sound system of the vehicle.

Clause 56: The non-transitory computer-readable medium of any one of the previous clauses, wherein the at least one corrective action comprises activating a driver assistance system of the vehicle.

Clause 57: The non-transitory computer-readable medium of any one of the previous clauses, wherein the at least one corrective action comprises activating an autonomous driving system of the vehicle.

Clause 58: The non-transitory computer-readable medium of any one of the previous clauses, wherein the at least one corrective action comprises alerting the occupant of the vehicle of the high emotional state.

Clause 59: The non-transitory computer-readable medium of any one of the previous clauses, wherein the at least one corrective action comprises reducing the sensitivity of at least one vehicle control.

Clause 60: The non-transitory computer-readable medium of any one of the previous clauses, wherein the at least one corrective action comprises preventing use of a mobile device of the occupant.

Clause 61: The non-transitory computer-readable medium of any one of the previous clauses, wherein the at least one corrective action comprises reducing a travel speed of the vehicle.

Clause 62: The non-transitory computer-readable medium of any one of the previous clauses, wherein the at least one corrective action comprises reducing a maximum speed of the vehicle.

Clause 63: The non-transitory computer-readable medium of any one of the previous clauses, wherein the at least one corrective action comprises establishing a communication link between the occupant and assistance.

Clause 64: The non-transitory computer-readable medium of any one of the previous clauses, wherein the steps further comprise receiving the captured data indicative of the emotional state of the occupant of the vehicle at a first predetermined time interval prior to recognizing that the occupant is in the high emotional state.

Clause 65: The non-transitory computer-readable medium of any one of the previous clauses, wherein the steps further comprise receiving, in response to the recognized high emotional state of the occupant, the captured data indicative of the emotional state of the occupant at a second predetermined time interval, the second predetermined time interval shorter than the first predetermined time interval.

Clause 66: The non-transitory computer-readable medium of any one of the previous clauses, wherein the data indicative of the emotional state of the occupant of the vehicle is captured utilizing a first occupant sensor prior to recognizing that the occupant is in the high emotional state.

Clause 67: The non-transitory computer-readable medium of any one of the previous clauses, wherein the steps further comprise capturing again, in response to the recognized high emotional state of the occupant, data indicative of the emotional state of the occupant of the vehicle utilizing a second occupant sensor different than the first occupant sensor.

Clause 68: The non-transitory computer-readable medium of any one of the previous clauses, wherein the first occupant sensor comprises an audio sensor or a microphone.

Clause 69: The non-transitory computer-readable medium of any one of the previous clauses, wherein the second occupant sensor comprises a visual sensor or camera.

Clause 70: The non-transitory computer-readable medium of any one of the previous clauses, wherein the first occupant sensor comprises a visual sensor or camera.

Clause 71: The non-transitory computer-readable medium of any one of the previous clauses, wherein the second occupant sensor comprises an audio sensor or a microphone.

Clause 72: The non-transitory computer-readable medium of any one of the previous clauses, wherein the steps further comprise capturing updated data indicative of an updated emotional state of the occupant of the vehicle subsequent to implementing the at least one corrective action.

Clause 73: The non-transitory computer-readable medium of any one of the previous clauses, wherein the steps further comprise recognizing that the occupant is in a normal emotional state based on the updated data indicative of the updated emotional state of the occupant.

Clause 74: The non-transitory computer-readable medium of any one of the previous clauses, wherein the steps further comprise terminating the at least one corrective action.

Clause 75: The non-transitory computer-readable medium of any one of the previous clauses, wherein the steps further comprise recognizing that the occupant is still in the high emotional state based on the updated data indicative of the updated emotional state of the occupant.

Clause 76: The non-transitory computer-readable medium of any one of the previous clauses, wherein the steps further comprise determining, in response to recognizing that the occupant is still in the high emotional state, at least one additional corrective action configured to calm the occupant from the high emotional state to the normal emotional state.

Clause 77: The non-transitory computer-readable medium of any one of the previous clauses, wherein the steps further comprise implementing the at least one additional corrective action.

What is claimed is:

1. A system for assisting a distracted vehicle occupant, the system comprising:
a first occupant sensor configured to capture data indicative of an emotional state of an occupant of the vehicle;
a distraction determination module comprising instructions stored in at least one memory and executable by one or more processors to cause the distraction determination module to:
recognize that the occupant is in a high emotional state based on the captured data indicative of the emotional state of the occupant;
determine, in response to the recognized high emotional state of the occupant, at least one corrective action configured to calm the occupant from the high emotional state to a normal emotional state; and
implement or cause to be implemented the at least one corrective action.

2. The system of claim 1, wherein the occupant comprises a driver or operator of the vehicle.

3. The system of claim 1, wherein the high emotional state is associated with at least one of occupant speech over a predetermined db level, an argument involving the occupant, the use of at least one trigger word by the occupant, an emotional facial expression of the occupant, or an erratic movement of the occupant.

4. The system of claim 1, wherein the high emotional state is recognized utilizing an artificial intelligence algorithm.

5. The system of claim 1, wherein the at least one corrective action comprises at least one of playing soothing ambient sounds or music, turning off a sound system of the vehicle, activating a driver assistance system of the vehicle, activating an autonomous driving system of the vehicle, alerting the occupant of the vehicle of the high emotional state, reducing a sensitivity of at least one vehicle control, preventing use of a mobile device of the occupant, reducing a travel speed or a maximum speed of the vehicle, or establishing a communication link between the occupant and assistance.

6. The system of claim 1, wherein causing the at least one corrective action to be implemented comprises communicating a signal to at least one of a subsystem of the system, another module of the system, or another system of the vehicle suitable to implement the at least one corrective action.

7. The system of claim 1, wherein the distraction determination module further comprises instructions stored in the at least one memory and executable by the one or more processors to cause the distraction determination module to:
receive the captured data indicative of the emotional state of the occupant of the vehicle at a first predetermined time interval prior to recognizing that the occupant is in the high emotional state; and
receive, in response to the recognized high emotional state of the occupant, the captured data indicative of the emotional state of the occupant at a second predetermined time interval, the second predetermined time interval shorter than the first predetermined time interval.

8. The system of claim 1, further comprising a second occupant sensor, different than the first occupant sensor, also configured to capture the data indicative of the emotional state of the occupant of the vehicle, wherein the distraction determination module further comprises instructions stored in the at least one memory and executable by the one or more processors to cause the distraction determination module to:
receive the captured data indicative of the emotional state of the occupant of the vehicle from the first occupant sensor but the not the second occupant sensor prior to recognizing that the occupant is in the high emotional state; and
receive, in response to the recognized high emotional state of the occupant, the captured data indicative of the emotional state of the occupant of the vehicle from the first occupant sensor and the second occupant sensor.

9. The system of claim 8, wherein the first occupant sensor comprises an audio sensor or a microphone, and the second occupant sensor comprises a visual sensor or camera.

10. The system of claim 1, wherein the distraction determination module further comprises instructions stored in the at least one memory and executable by the one or more processors to cause the distraction determination module to:
receive updated captured data indicative of an updated emotional state of the occupant of the vehicle subsequent to implementation of the at least one corrective action;
recognize that the occupant is in a normal emotional state based on the updated captured data indicative of the updated emotional state of the occupant; and
terminate or cause to be terminated the at least one corrective action.

11. The system of claim 1, wherein the distraction determination module further comprises instructions stored in the at least one memory and executable by the one or more processors to cause the distraction determination module to:
receive updated captured data indicative of an updated emotional state of the occupant of the vehicle subsequent to implementation of the at least one corrective action;
recognize that the occupant is still in the high emotional state based on the updated captured data indicative of the updated emotional state of the occupant;
determine, in response to recognizing that the occupant is still in the high emotional state, at least one additional corrective action configured to calm the occupant from the high emotional state to the normal emotional state; and
implement or cause to be implemented the at least one additional corrective action.

12. A non-transitory computer-readable medium comprising instructions stored in at least one memory that, when executed by one or more processors, cause the one or more processors to carry out steps comprising:
capturing data indicative of an emotional state of an occupant of a vehicle;
recognizing that the occupant is in a high emotional state based on the captured data indicative of the emotional state of the occupant;
determining, in response to the recognized high emotional state of the occupant, at least one corrective action configured to calm the occupant from the high emotional state to a normal emotional state; and
implementing the at least one corrective action.

13. The non-transitory computer-readable medium of claim 12, wherein the occupant comprises a driver or operator of the vehicle.

14. The non-transitory computer-readable medium of claim 12, wherein the high emotional state is associated with at least one of occupant speech over a predetermined db level, an argument involving the occupant, the use of at least one trigger word by the occupant, an emotional facial expression of the occupant, or an erratic movement of the occupant.

15. The non-transitory computer-readable medium of claim 12, wherein the at least one corrective action comprises at least one of playing soothing ambient sounds or music, turning off a sound system of the vehicle, activating a driver assistance system of the vehicle, activating an autonomous driving system of the vehicle, alerting the occupant of the vehicle of the high emotional state, reducing the sensitivity of at least one vehicle control, preventing use of a mobile device of the occupant, reducing a travel speed or a maximum speed of the vehicle, or establishing a communication link between the occupant and assistance.

16. The non-transitory computer-readable medium of claim 12, wherein the steps further comprise:
receiving the captured data indicative of the emotional state of the occupant of the vehicle at a first predetermined time interval prior to recognizing that the occupant is in the high emotional state; and
receiving, in response to the recognized high emotional state of the occupant, the captured data indicative of the emotional state of the occupant at a second predetermined time interval, the second predetermined time interval shorter than the first predetermined time interval.

17. The non-transitory computer-readable medium of claim 12, wherein the data indicative of the emotional state of the occupant of the vehicle is captured utilizing a first occupant sensor prior to recognizing that the occupant is in the high emotional state, and wherein the steps further comprise:
capturing again, in response to the recognized high emotional state of the occupant, data indicative of the emotional state of the occupant of the vehicle utilizing a second occupant sensor different than the first occupant sensor.

18. The non-transitory computer-readable medium of claim 17, wherein the first occupant sensor comprises an audio sensor or a microphone, and the second occupant sensor comprises a visual sensor or camera.

19. The non-transitory computer-readable medium of claim 12, wherein the steps further comprise:
capturing updated data indicative of an updated emotional state of the occupant of the vehicle subsequent to implementing the at least one corrective action;
recognizing that the occupant is in a normal emotional state based on the updated data indicative of the updated emotional state of the occupant; and
terminating the at least one corrective action.

20. The non-transitory computer-readable medium of claim 12, wherein the steps further comprise:
capturing updated data indicative of an updated emotional state of the occupant of the vehicle subsequent to implementing the at least one corrective action;
recognizing that the occupant is still in the high emotional state based on the updated data indicative of the updated emotional state of the occupant;
determining, in response to recognizing that the occupant is still in the high emotional state, at least one additional corrective action configured to calm the occupant from the high emotional state to the normal emotional state; and
implementing the at least one additional corrective action.
